(19) United States
(12) Patent Application Publication
(10) Pub. No.: US 2022/0073078 A1
(43) Pub. Date: Mar. 10, 2022

(54) RUT DETERMINATION DEVICE, RUT DETERMINATION METHOD, AND STORAGE MEDIUM

(71) Applicant: Toyota Jidosha Kabushiki Kaisha, Toyota-shi Aichi-ken (JP)

(72) Inventors: Yohsuke Kimura, Nissin-shi (JP); Takeo Moriai, Nagakute-shi (JP); Tatsuya Obuchi, Obu-shi (JP); Masaya Fujimori, Susono-shi (JP)

(73) Assignee: Toyota Jidosha Kabushiki Kaisha, Toyota-shi Aichi-ken (JP)

(21) Appl. No.: 17/367,959

(22) Filed: Jul. 6, 2021

(30) Foreign Application Priority Data
Sep. 8, 2020 (JP) 2020-150519

(51) Int. Cl. B60W 40/06; B60W 40/103; B60W 40/105; B60W 50/00; G06K 9/00

(52) U.S. Cl. CPC B60W 40/06; B60W 40/103; B60W 40/105; B60W 2556/65; G06K 9/00798; B60W 2050/0055; B60W 2552/35; B60W 50/00

(57) ABSTRACT

A rut determination device is configured to determine, for each road section, presence or absence of a rut based on any one of a plurality of first variation quantities each of which is the variation quantity of a vehicle-body slip angular velocity per unit time for each vehicle, a plurality of first processed values each of which is a value obtained by performing predetermined processing for each of the plurality of the first variation quantities, a plurality of second variation quantities each of which is the variation quantity of a vehicle-body slip-related value, which is the product of the vehicle-body slip angular velocity and the vehicle speed for each vehicle, per unit time, and a plurality of second processed values each of which is a value obtained by performing the predetermined processing for each of the plurality of the second variation quantities.

### CROSS-REFERENCE TO RELATED APPLICATION

This application claims priority to Japanese Patent Application No. 2020-150519 filed on Sep. 8, 2020, incorporated herein by reference in its entirety.

### BACKGROUND

### 1. Technical Field

The present disclosure relates to a rut determination device, a rut determination method, and a storage medium.

### 2. Description of Related Art

As a conventional technique in this field, a road surface property inspection system is proposed (for example, Japanese Unexamined Patent Application Publication No. 2019-125038 (JP 2019-125038 A)). This system detects the presence or absence of a concave portion, such as a rut, at a certain position on a road by comparing the characteristics of the traveling sounds collected by each of a plurality of vehicles when the road surface is wet with the characteristics of the traveling sounds collected by each of a plurality of vehicles when the road surface is dry.

### SUMMARY

In the road surface property inspection system described above, the traveling sounds collected by each of a plurality of vehicles are used. However, the traveling sounds collected in this way include sounds generated not only by a concave portion such as a rut but also sounds not related to a concave portion. This means that the determination accuracy of the presence or absence of a rut may be reduced. In consideration of this, it is required to provide a new method for determining the presence or absence of a rut.

The main purpose of a rut determination device, a rut determination method, and a storage medium of the present disclosure is to provide a new method for determining the presence or absence of a rut in each road section.

To achieve the purpose described above, the rut determination device, the rut determination method, and the storage medium of the present disclosure are provided.

A first aspect of the present disclosure relates to a rut determination device configured to determine, for each road section, the presence or absence of a rut based on vehicle information from each vehicle that has traveled in the each road section. The rut determination device includes a processing unit configured to determine, for each road section, the presence or absence of the rut based on any one of a plurality of first variation quantities, a plurality of first processed values, a plurality of second variation quantities, a plurality of second processed values, and a plurality of third processed values. The plurality of the first variation quantities is each the variation quantity of the vehicle-body slip angular velocity per unit time for each vehicle. The plurality of the first processed values is each a value obtained by performing predetermined processing for each of the plurality of the first variation quantities. The predetermined processing includes high-pass filtering processing. The plurality of the second variation quantities is each the variation quantity of the vehicle-body slip-related value per unit time. The vehicle-body slip-related value is the product of the vehicle-body slip angular velocity and the vehicle speed for each vehicle. The plurality of the second processed values is each a value obtained by performing the predetermined processing for each of the plurality of the second variation quantities. The plurality of the third processed values is each a value obtained by performing arithmetic processing to obtain the absolute difference between the current value and the previous value for each of any of the plurality of the first variation quantities, the plurality of the first processed values, the plurality of the second variation quantities, and the plurality of the second processed values.

The rut determination device of the present disclosure determines, for each road section, the presence or absence of a rut based on any one of the plurality of first variation quantities, the plurality of first processed values, the plurality of second variation quantities, the plurality of second processed values, and the plurality of third processed values. The plurality of the first variation quantities is each the variation quantity of the vehicle-body slip angular velocity per unit time for each vehicle. The plurality of the first processed values is each a value obtained by performing predetermined processing for each of the plurality of the first variation quantities. The predetermined processing includes high-pass filtering processing. The plurality of the second variation quantities is each the variation quantity of the vehicle-body slip-related value per unit time. The vehicle-body slip-related value is the product of the vehicle-body slip angular velocity and the vehicle speed for each vehicle. The plurality of the second processed values is each a value obtained by performing the predetermined processing for each of the plurality of the second variation quantities. The plurality of the third processed values is each a value obtained by performing arithmetic processing to obtain the absolute difference between the current value and the previous value for each of any of the plurality of the first variation quantities, the plurality of the first processed values, the plurality of the second variation quantities, and the plurality of the second processed values. When the vehicle is affected by a rut, it is assumed that the vehicle-body slip angular velocity and the vehicle-body slip-related value will vary. Therefore, it is possible to determine the presence or absence of a rut by using any one of the plurality of the first variation quantities, the plurality of the first processed values, the plurality of the second variation quantities, the plurality of the second processed values, and the plurality of the third processed values. Moreover, since the predetermined processing includes the high-pass filtering processing, it is possible to obtain the plurality of the first processed values by removing the low frequency components included in the plurality of the first variation quantities and to obtain the plurality of the second processed values by removing the low frequency components included in the plurality of the second variation quantities. Therefore, the presence or absence of a rut can be appropriately determined by determining the presence or absence of a rut based on any one of the plurality of the first processed values, the plurality of the second processed values, and the plurality of the third processed values that are based on the plurality of the first processed values and the plurality of the second processed values. Examples of “low frequency components” include components caused by a driver's operation on an operating device (for example, accelerator pedal operation, steering wheel operation, etc.)

In the rut determination device of the present disclosure, the processing unit may be configured to determine the presence or absence of the rut by determining whether the number or ratio of first determination values is equal to or larger than a second threshold value. The number or ratio of the first determination values is the number or ratio of the first determination values that are included in a plurality of the first determination values and that each have an absolute value equal to or larger than a first threshold value. The plurality of the first determination values is any one of the plurality of the first variation quantities, the plurality of the first processed values, the plurality of the second variation quantities, the plurality of the second processed values, and the plurality of the third processed values. This allows the rut determination device to determine the presence or absence of a rut more appropriately.

In the rut determination device of the present disclosure, the processing unit may be configured to estimate a rut level based on any one of the plurality of the first variation quantities, the plurality of the first processed values, the plurality of the second variation quantities, the plurality of the second processed values, and the plurality of the third processed values when it is determined that there is the rut, for the each road section. This allows the rut determination device not only to determine the presence or absence of a rut but also to estimate the rut level.

In this case, the processing unit may be configured to estimate the rut level by determining whether the number or ratio of second determination values is equal to or larger than a fourth threshold value. The number or ratio of the second determination values is the number of the second determination values that are included in a plurality of the second determination values and that each have an absolute value equal to or larger than a third threshold value. The plurality of second determination values is any one of the plurality of the first variation quantities, the plurality of the first processed values, the plurality of the second variation quantities, the plurality of the second processed values, and the plurality of the third processed values. This allows the rut determination device to estimate the rut level more appropriately.

In the rut determination device of the present disclosure, the processing unit may be configured to change a determination to a determination that there is the rut in a first target section when it is determined that there is no rut in the first target section but when it is determined that there is the rut in two road sections adjacent to the first target section in a road extending direction. The target section is the road section that is a target selected from the each road sections. This is because, when there is a rut in the two road sections adjacent to the target section in the road extending direction, there is a possibility that there is a rut also in the target section (the rut continues from the target section to the adjacent section).

In the rut determination device of the present disclosure, the processing unit may be configured to change a determination to a determination that there is no rut in a second target section when it is determined that there is the rut in the second target section but when it is determined that the number of continuous road sections, which include the second target section and are determined to have the rut is smaller than a threshold value. The second target section is the road section that is a target selected from the road sections. The number of continuous road sections includes the each target section. This is because, when the number of continuous road sections that are determined to have a rut is few, there is a possibility that there is a manhole cover or a railroad crossing instead of a rut in the target section.

A second aspect of the present disclosure relates to a rut determination method for determining, for each road section, the presence or absence of a rut based on vehicle information from each vehicle that has traveled in the each road section. The rut determination method includes determining, for each road section, the presence or absence of the rut based on any one of a plurality of first variation quantities, a plurality of first processed values, a plurality of second variation quantities, a plurality of second processed values, and a plurality of third processed values. The plurality of the first variation quantities is each the variation quantity of the vehicle-body slip angular velocity per unit time for each vehicle. The plurality of the first processed values is each a value obtained by performing predetermined processing for each of the plurality of the first variation quantities. The predetermined processing includes high-pass filtering processing. The plurality of the second variation quantities is each the variation quantity of a vehicle-body slip-related value per unit time. The vehicle-body slip-related value is each the product of the vehicle-body slip angular velocity and the vehicle speed for each vehicle. The plurality of the second processed values is each a value obtained by performing the predetermined processing for each of the plurality of the second variation quantities. The plurality of the third processed values is each a value obtained by performing arithmetic processing to obtain the absolute difference between the current value and the previous value for each of any of the plurality of the first variation quantities, the plurality of the first processed values, the plurality of the second variation quantities, and the plurality of the second processed values.

The rut determination method of the present disclosure determines, for each road section, the presence or absence of a rut based on any one of the plurality of first variation quantities, the plurality of first processed values, the plurality of second variation quantities, the plurality of second processed values, and the plurality of third processed values. The plurality of the first variation quantities is each the variation quantity of the vehicle-body slip angular velocity per unit time for each vehicle. The plurality of the first processed values is each a value obtained by performing predetermined processing for each of the plurality of the first variation quantities. The predetermined processing includes high-pass filtering processing. The plurality of the second variation quantities is each the variation quantity of the vehicle-body slip-related value per unit time. The vehicle-body slip-related value is the product of the vehicle-body slip angular velocity and the vehicle speed for each vehicle. The plurality of the second processed values is each a value obtained by performing the predetermined processing for each of the plurality of the second variation quantities. The plurality of the third processed values is each a value obtained by performing arithmetic processing to obtain the absolute difference between the current value and the previous value for each of any of the plurality of the first variation quantities, the plurality of the first processed values, the plurality of the second variation quantities, or the plurality of the second processed values. When the vehicle is affected by a rut, it is assumed that the vehicle-body slip angular velocity and the vehicle-body slip-related value will vary. Therefore, it is possible to determine the presence or absence of a rut by using any one of the plurality of the first variation quantities, the plurality of the first processed values, the plurality of the second variation quantities, the plurality of the second processed values, and the plurality of the third processed values. Moreover, since the predetermined processing includes the high-pass filtering processing, it is possible to obtain the plurality of the first processed values by removing the low frequency components included in the plurality of the first variation quantities and to obtain the plurality of the second processed values by removing the low frequency components included in the plurality of the second variation quantities. Therefore, the presence or absence of a rut can be appropriately determined by determining the presence or absence of a rut based on any one of the plurality of the first processed values, the plurality of the second processed values, and the plurality of the third processed values that are based on the plurality of the first processed values and the plurality of the second processed values. Examples of “low frequency components” include components caused by a driver's operation on an operating device (for example, accelerator pedal operation, steering wheel operation, etc.)

A third aspect of the present disclosure relates to a storage medium storing a program for causing a computer to function as a rut determination device configured to determine, for each road section, presence or absence of a rut based on vehicle information from each vehicle that has traveled in the each road section. The program includes determining, for each road section, the presence or absence of the rut based on any one of a plurality of first variation quantities, a plurality of first processed values, a plurality of second variation quantities, a plurality of second processed values, and a plurality of third processed values. The plurality of the first variation quantities is each the variation quantity of the vehicle-body slip angular velocity per unit time for each vehicle. The plurality of the first processed values is each a value obtained by performing predetermined processing for each of the plurality of the first variation quantities. The predetermined processing includes high-pass filtering processing. The plurality of the second variation quantities is each the variation quantity of a vehicle-body slip-related value per unit time. The vehicle-body slip-related value is the product of the vehicle-body slip angular velocity and the vehicle speed for each vehicle. The plurality of the second processed values is each a value obtained by performing the predetermined processing for each of the plurality of the second variation quantities. The plurality of the third processed values is each a value obtained by performing arithmetic processing to obtain the absolute difference between the current value and the previous value for each of any of the plurality of the first variation quantities, the plurality of the first processed values, the plurality of the second variation quantities, and the plurality of the second processed values.

The storage medium of the present disclosure determines, for each road section, the presence or absence of a rut based on any one of the plurality of first variation quantities, the plurality of first processed values, the plurality of second variation quantities, the plurality of second processed values, and the plurality of third processed values. The plurality of the first variation quantities is each the variation quantity of the vehicle-body slip angular velocity per unit time for each vehicle. The plurality of the first processed values is each a value obtained by performing predetermined processing for each of the plurality of the first variation quantities. The predetermined processing includes high-pass filtering processing. The plurality of the second variation quantities is each the variation quantity of the vehicle-body slip-related value per unit time. The vehicle-body slip-related value is the product of the vehicle-body slip angular velocity and the vehicle speed for each vehicle. The plurality of the second processed values is each a value obtained by performing the predetermined processing for each of the plurality of the second variation quantities. The plurality of the third processed values is each a value obtained by performing arithmetic processing to obtain the absolute difference between the current value and the previous value for each of any of the plurality of the first variation quantities, the plurality of the first processed values, the plurality of the second variation quantities, or the plurality of the second processed values. When the vehicle is affected by a rut, it is assumed that the vehicle-body slip angular velocity and the vehicle-body slip-related value will vary. Therefore, it is possible to determine the presence or absence of a rut by using any one of the plurality of the first variation quantities, the plurality of the first processed values, the plurality of the second variation quantities, the plurality of the second processed values, and the plurality of the third processed values. Moreover, since the predetermined processing includes the high-pass filtering processing, it is possible to obtain the plurality of the first processed values by removing the low frequency components included in the plurality of the first variation quantities and to obtain the plurality of the second processed values by removing the low frequency components included in the plurality of the second variation quantities. Therefore, the presence or absence of a rut can be appropriately determined by determining the presence or absence of a rut based on any one of the plurality of the first processed values, the plurality of the second processed values, and the plurality of the third processed values that are based on the plurality of the first processed values and the plurality of the second processed values. Examples of “low frequency components” include components caused by a driver's operation on an operating device (for example, accelerator pedal operation, steering wheel operation, etc.)

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing the outline of a configuration of a road management system 10 that includes a rut determination device;

FIG. 2 is a flowchart showing an example of a preparatory processing routine;

FIG. 3 is a flowchart showing an example of a rut determination processing routine;

FIG. 4 is a diagram showing an example of how a vehicle 50 drives over ruts;

FIG. 5 is a diagram showing an example of the relationship between a third processed value γp[k] and a rut concavity level;

FIG. 6 is a flowchart showing an example of an image processing routine executed by an information providing unit 24;

FIG. 7 is a diagram showing an example of rut level images Im1 to Im3 included in an image displayed on a display 43;

FIG. 8 is a flowchart showing an example of the rut determination processing routine; and

FIG. 9 is a flowchart showing an example of the rut determination processing routine.

### DETAILED DESCRIPTION OF EMBODIMENTS

Next, a mode for carrying out the present disclosure will be described below using an embodiment.

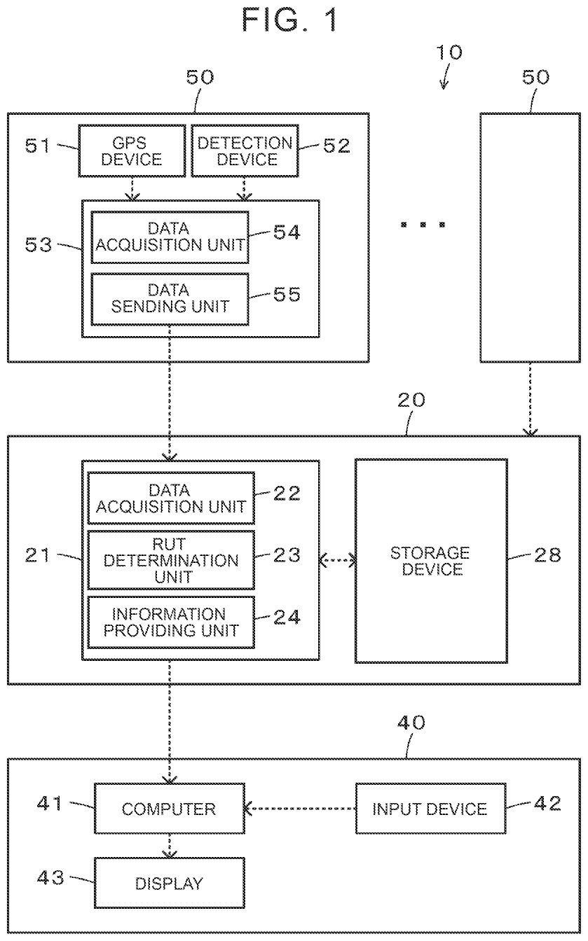

FIG. 1 is a configuration diagram showing the outline of the configuration of a road management system 10 that includes a rut determination device that is one embodiment of the present disclosure. As shown in the figure, the road management system 10 in the embodiment includes a server 20 that can communicate wirelessly with each vehicle 50 and a terminal device 40 that can communicate, wirelessly or by cable, with the server 20. In the description below, roads include not only public roads (roadways and sidewalks) but also private roads and parking lots (for example, passages). The “rut determination device” in the embodiment is the server 20.

Each of the vehicles 50 includes a GPS device 51 that acquires position information on the current position of the vehicle, a detection device 52 that detects the behavior information on the behavior of the vehicle 50, and an electronic control unit (hereinafter referred to as “ECU”) 53. The detection device 52 includes sensors that detect the information indicating the behavior of the vehicle 50, sensors that detect the information affecting the behavior of the vehicle 50, and sensors that detect the information around the vehicle 50.

The information indicating the behavior of the vehicle 50 includes, for example, at least one of the vehicle speed or wheel speed, longitudinal acceleration, lateral acceleration, yaw rate, yaw angle, roll angle, pitch angle, and vehicle-body slip ratio of tires.

The information affecting the behavior of the vehicle 50 includes, for example, the operating state of an operating device that can be operated by the driver and the operating state of an assistance system that assists in the travelling of the vehicle 50. The operating state of an operating device includes, for example, at least one of the steering angle and steering speed of the steering wheel, the depression amount of the accelerator pedal, the depression amount of the brake pedal, the shift position of the shift lever, and whether the direction indicator is operated. In addition, the assistance systems include at least one of the Lane Departure Alert (LDA) system, Anti-lock Brake System (ABS), TRaction Control (TRC) system, and Electronic Stability Control (ESC) system.

The sensors that detect the information around the vehicle 50 include, for example, at least one of a camera, a radar, a Light Detection and Ranging (Lidar).

The ECU 53 includes a CPU, a ROM, a RAM, a flash memory, an input/output port, and a communication port. The ECU 53 includes a data acquisition unit 54 and a data sending unit 55 as the functional blocks that are implemented by a combination of hardware and software. The data acquisition unit 54 acquires the position information on the vehicle 50 from the GPS device 51, and the behavior information on the vehicle 50 from the detection device 52. The data sending unit 55 wirelessly sends the position information and the behavior information on the vehicle 50, both of which are acquired by the data acquisition unit 54, to the server 20 as the vehicle information.

The server 20 is configured as a computer that includes an arithmetic processing unit 21 and a storage device 28. The arithmetic processing unit 21 includes a CPU, a ROM, a RAM, a flash memory, an input/output port, and a communication port. This arithmetic processing unit 21 includes a data acquisition unit 22, a rut determination unit 23, and an information providing unit 24 as the functional blocks that are implemented by a combination of hardware and software. Each of the data acquisition unit 22, the rut determination unit 23, and the information providing unit 24 exchanges data with the storage device 28.

The data acquisition unit 22 wirelessly acquires the vehicle information from a plurality of the vehicles 50 and stores the acquired vehicle information in the storage device 28. The rut determination unit 23 periodically determines the presence or absence of a rut for each road section in a management range based on the vehicle information received from the plurality of the vehicles 50, and stores the determination result in the storage device 28. In this specification, a “management range” is defined as a range (for example, a prefecture range or a municipality range) desired by a user (for example, a person in a government office). A “road section” is defined, for example, as a section of several tens of centimeters to several meters. When there are inbound/outbound roads, each road is defined as a separate section. The detail of the rut determination unit 23 will be described later.

The information providing unit 24 sends various type of information to a computer 41 of the terminal device 40. The storage device 28 is configured as a hard disk drive, a solid state drive (SSD), or the like. This storage device 28 stores various types of information necessary for the operation of the arithmetic processing unit 21. Examples of information stored in the storage device 28 include the map information, the vehicle information on a plurality of the vehicle 50 acquired by the data acquisition unit 22, and the information stored by the rut determination unit 23.

The terminal device 40 is configured as a desktop personal computer, a notebook computer, or a tablet terminal. The terminal device 40 includes the computer 41, an input device 42 connected to the computer 41, and a display 43 used as a display device. The computer 41 includes a CPU, a ROM, a RAM, a flash memory, a storage device (hard disk drive or SSD), an input/output port, a communication port, and the like. Examples of the input device 42 include a mouse, a keyboard, and a touch panel.

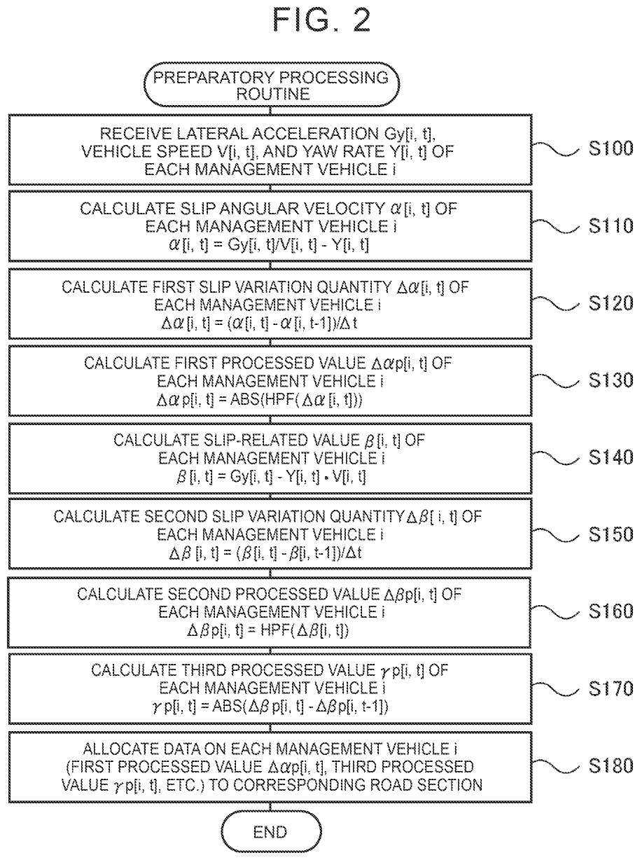

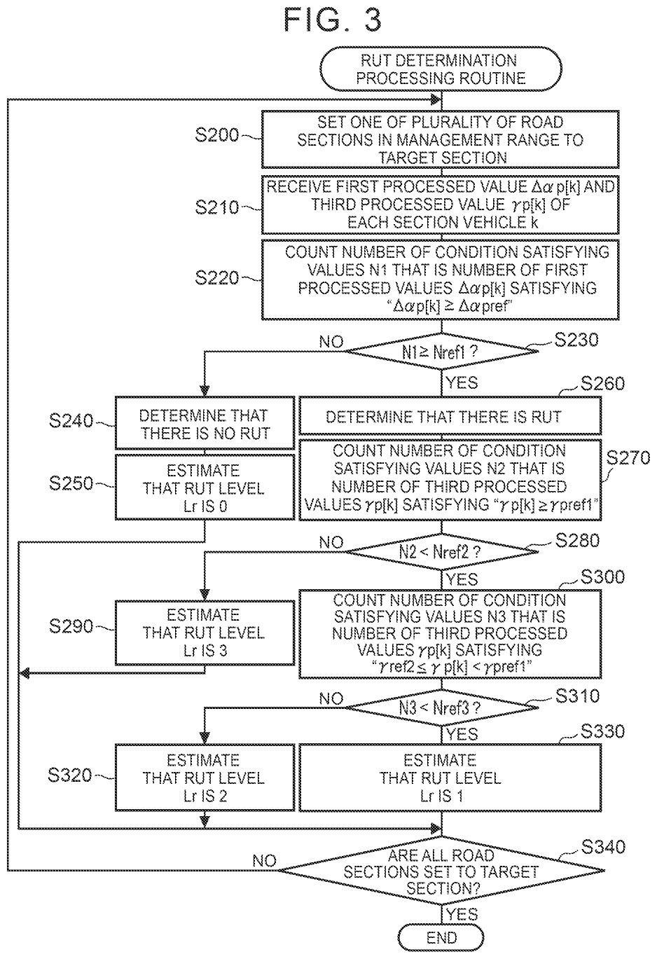

Next, the operation of the server 20 in the embodiment configured in this way will be described below, with emphasis on the operation of the rut determination unit 23 and the information providing unit 24. The operation of the rut determination unit 23 will be described first, followed by description of the operation of the information providing unit 24. FIG. 2 is a flowchart showing an example of the preparatory processing routine executed by the rut determination unit 23, and FIG. 3 is a flowchart showing an example of the rut determination processing routine executed by the rut determination unit 23. These routines are executed periodically (for example, every day or every few days) in the order of the preparatory processing routine shown in FIG. 2 and the rut determination processing routine shown in FIG. 3.

First, the preparatory processing routine in FIG. 2 will be described. When this routine is executed, the rut determination unit 23 first receives the time-series data on each management vehicle i that is each of the vehicles 50 that have traveled on a road in the management range during a predetermined period of time (step S100). The time-series data includes the lateral acceleration Gy[i, t], vehicle speed V[i, t], and yaw rate Y[i, t] at each time t. The “predetermined period of time” is determined based on the execution interval of this routine; for example, when this routine is executed every day, the predetermined period of time is defined as one day (24 hours) before this routine is executed. “i” is a variable corresponding to each management vehicle. In this embodiment, the variable i is assigned to each trip of each of the vehicles 50 that have traveled on the road in the management range during the predetermined period of time. This means that a plurality of variables i may be assigned to one vehicle 50. “t” is a variable corresponding to each time. In this embodiment, for each management vehicle i, the lateral acceleration Gy[i, t], vehicle speed V[i, t], and yaw rate Y[i, t] at each time t are associated with a point where the vehicle has traveled at each time tin the management range.

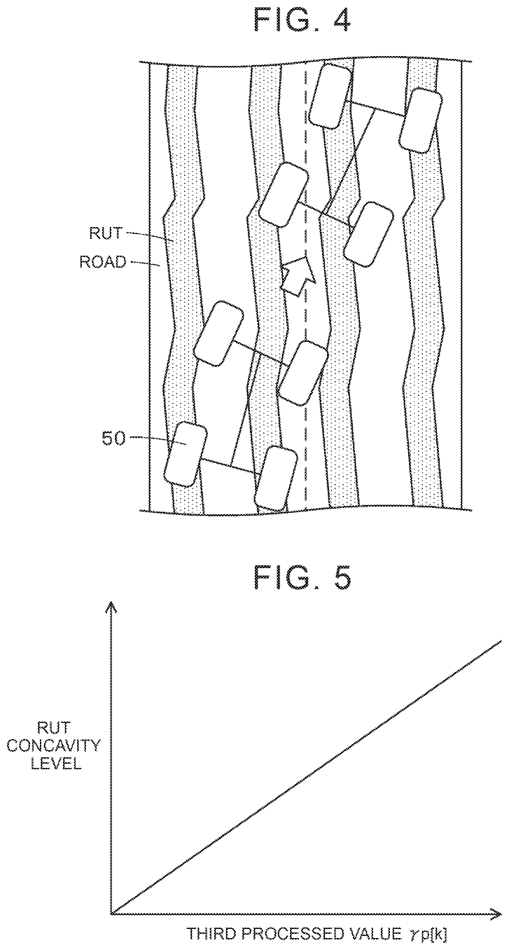

When the data is received in this way, the vehicle-body slip angular velocity α[i, t] at each time t is calculated for each management vehicle i (step S110). The vehicle-body slip angular velocity α[i, t] is calculated by subtracting the yaw rate Y[i, t] from the value obtained by dividing the lateral acceleration Gy[i, t] by the vehicle speed V[i, t], as shown in expression (1). FIG. 4 is a diagram showing an example of how the vehicle 50 drives over ruts. When the vehicle 50 is affected by a rut, such as when the vehicle 50 drives over ruts as shown in FIG. 4, it is assumed that the vehicle 50 receives the road surface reaction force from the rut with the result that the behavior of the vehicle 50 (vehicle speed V, lateral acceleration Gy, yaw rate Y, vehicle-body slip angular velocity α, etc.) will vary. Expression (1) is obtained as the motion equation of a vehicle model when the vehicle 50 is affected by a rut. Therefore, the vehicle-body slip angular velocity α[i, t] can be calculated by using expression (1).

α[i,t]=Gy[i,t]/V[i,t]−Y[i,t] (1)

Next, for each management vehicle i, the first slip variation quantity Δα[i, t] at each time t is calculated (step S120). The first slip variation quantity Δα[i, t] is the variation quantity of the vehicle-body slip angular velocity α[i, t] per unit time. As shown in expression (2), the first slip variation quantity Δα[i, t] is calculated by dividing the value, obtained by subtracting the vehicle-body slip angular velocity α[i, t−1] at time (t−1) from the vehicle-body slip angular velocity α[i, t] at time t, by the time interval Δt between time t and time (t−1). The time interval Δt is, for example, about several tens of msec to several hundreds of msec.

Δα[i,t]=(α[i,t]−α[i,t−1])/Δt (2)

Then, for each management vehicle i, the first processed value Δαp[i, t] at each time t is calculated (step S130). To calculate the first processed value Δαp[i, t], the high-pass filtering processing (HPF) is performed for the first slip variation quantity Δα[i, t] and, for the resulting value, the absolute value acquisition processing (ABS) is further performed as shown in expression (3). By performing high-pass filter processing in this way, the low frequency components included in the first slip variation quantity Δα[i, t] are removed and, as a result, the first processed value Δαp[i, t] can be obtained. Examples of “low frequency components” include components caused by a driver's operation on an operating device (for example, accelerator pedal operation, steering wheel operation, etc.)

Δαp[i,t]=ABS(HPF(Δα[i,t])) (3)

In addition, for each management vehicle i, the vehicle-body slip-related value β[i, t] at each time t is calculated (step S140). The vehicle-body slip-related value β[i, t] is a value related to the vehicle-body slip angular velocity α[i, t]. The vehicle-body slip-related value β[i, t] is calculated by subtracting the product of the yaw rate Y[i, t] and the vehicle speed V[i, t] from the lateral acceleration Gy[i, t], as shown in expression (4). Expression (4) corresponds to the expression generated by multiplying both sides of expression (1) by the vehicle speed V[i, t] and, in addition, by replacing “α[i, t] ·V[i, t]” on the left-hand side with “β[i, t]”. Therefore, instead of expression (4), the vehicle-body slip-related value β[i, t] may be calculated as the product of the vehicle-body slip angular velocity α[i, t] and the vehicle speed V[i, t].

β[i,t]=Gy[i,t]−Y[i,t]·V[i,t] (4)

Next, for each management vehicle i, the second slip variation quantity Δβ[i, t] at each time t is calculated (step S150). The second slip variation quantity Δβ[i, t] is the variation quantity of the vehicle-body slip-related value β[i, t] per unit time. The second slip variation quantity Δβ[i, t] is calculated by dividing the value, calculated by subtracting the vehicle-body slip-related value β[i, t−1] at time (t−1) from the vehicle-body slip-related value β[i, t] at time t, by the above-described time interval Δt, as shown in expression (5).

Δβ[i,t]=(β[i,t]−β[i,t−1])/Δt (5)

Then, for each management vehicle i, the second processed value Δβp[i, t] at each time t is calculated (step S160). The second processed value Δβp[i, t] is calculated by performing high-pass filtering processing (HPF) for the second slip variation quantity Δβ[i, t], as shown in expression (6). By performing the high-pass filtering processing in this way, the low-frequency components included in the second slip variation quantity Δβ[i, t] are removed and the second processed value Δβp[i, t] can be obtained.

Δβp[i,t]=HPF(Δβ[i,t]) (6)

In addition, for each management vehicle i, the third processed value γp[i, t] at each time t is calculated (step S170). To calculate the third processed value γp[i, t], the second processed value Δβp[i, t−1] at time (t−1) is subtracted from the second processed value Δβp[i, t] at time t and, for the resulting value, the absolute value acquisition processing (ABS) is performed as shown in expression (7).

γp[i,t]=ABS(Δβp[i,t]−Δβp[i,t−1]) (7)

In addition, the data on each management vehicle i (first processed value Δαp[i, t], third processed value γp[i, t], etc.) is allocated to the corresponding road section (road section including the point where the vehicle traveled at time t) that is one of the plurality of the road sections in the management range (step S180). After that, this routine is terminated.

Next, the rut determination processing routine in FIG. 3 will be described. In this routine, it is not necessary to take into account the time for the data on each management vehicle i (first processed value Δαp[i, t], third processed value γp[i, t], etc.) that has been allocated to the corresponding road sections during the execution of the preparatory processing shown in FIG. 2. Therefore, the data used in the description below is the data on the section vehicles k (first processed value Δαp[k], third processed value γp[k], etc.) each of which is the vehicle 50 that has allocated the data to the corresponding road section. When this routine is executed, the rut determination unit 23 first selects one road section from the road sections that are included in the plurality of the road sections in the management range and that are not set to a target section by this routine and sets the selected road section to a target section (step S200). Next, for the target section, the rut determination unit 23 receives the first processed values Δαp[k] and the third processed values γp[k] of each section vehicle k (step S210).

Then, for the target section, the number of condition satisfying values N1, which is the number of first processed values Δαp[k] included in the first processed values Δαp[k] of each section vehicle k and satisfying “Δαp[k] Δαpref”, is counted (step S220). Then, the counted number of condition satisfying values N1 is compared with the threshold value Nref1 (step S230). The threshold value Δαpref and the threshold value Nref1, which are threshold values used to determine the presence or absence of a rut in the target section, are predetermined by experiment and analysis, respectively. For example, as the threshold value Nref1, the value range of about 1 to 3 is used. As mentioned above, when the vehicle 50 is affected by a rut, it is assumed that the behavior of the vehicle 50 (vehicle-body slip angular velocity α, etc.) will vary. Therefore, it is possible to determine the presence or absence of a rut in the target section by using the first processed value Δαp[i, t] (the first processed value Δαp[k] of each section vehicle k) that is based on the first slip variation quantity Δα[i, t] that is based on the vehicle-body slip angular velocity α[i, t] for each management vehicle i. Moreover, for each management vehicle i, the high-pass filtering processing is performed for the first slip variation quantity Δα[i, t] and, for the resulting value, the absolute value acquisition processing is further performed to calculate the first processed value Δαp[i, t]. This processing allows the low-frequency components in the first slip variation quantity Δα[i, t] to be removed to obtain the first processed value Δαp[i, t], making it possible to determine the presence or absence of a rut more appropriately for each road section.

When the number of first condition satisfying values N1 is smaller than threshold value Nref1 in step S230, it is determined that there is no rut in the target section (step S240) and it is estimated that the rut level Lr is 0 (step S250). The rut level Lr is the level of classification related to the rut concavity level, indicating that the larger the rut level Lr is, the larger the rut concavity level is. In the embodiment, this rut level Lr is divided into four levels: 0 when there is no rut, and 1-3 when there is a rut. After step S250, it is determined whether all the road sections in the management range have been set to a target section (step S340). When it is determined that some road sections in the management range have not been set to a target section, the processing return to step S200.

When the number of first condition satisfying values N1 is equal to or larger than the threshold value Nref1 in step S230, it is determined that there is a rut in the target section (step S260). In this case, the rut level estimation processing is performed for estimating the rut level Lr in the target section (steps S270 to S330). FIG. 5 is a diagram showing an example of the relationship between the third processed value γp[k] of each section vehicle k and the rut concavity level. Through experiment and analysis, the present inventors have found that the larger the third processed value γp[k] of each section vehicle k, the larger the rut concavity level, as shown in the figure. In the embodiment, the rut level estimation processing is performed based on this fact.

In the rut level estimation processing, the number of condition satisfying values N2, which is the number of third processed values γp[k] included in the third processed values γp[k] of each section vehicle k and satisfying “γp[k]≥γpref1”, is counted first for the target section (step S270). Then, the counted number of condition satisfying values N2 is compared with the threshold value Nref2 (step S280). The threshold value γpref1 is the lower limit value of the region where the rut level Lr for the third processed value γp[k] is 3. The threshold value γpref1 is predetermined by experiment or analysis. The threshold value Nref2, which is the value for estimating that the rut level Lr is 3, is predetermined by experiment or analysis. For example, as the threshold value Nref2, the value range of about 3 to 7 is used. When the number of condition satisfying values N2 is equal to or larger than the threshold value Nref2 in step S280, it is estimated that the rut level Lr is 3 (step S290).

When the number of condition satisfying values N2 is smaller than the threshold value Nref2 in step S280, the number of condition satisfying values N3, which is the number of third processed values γp[k] included in the third processed values γp[k] of each section vehicle k and satisfying “γref2≤γp[k]<γpref1”, is counted for the target section (step S300). Then, the counted number of condition satisfying values N3 is compared with the threshold value Nref3 (step S310). The threshold value γpref2, which is smaller than the threshold value γpref1, is the lower limit value of the region where the rut level Lr for the third processed value γp[k] is 2. The threshold value γpref2 is predetermined by experiment or analysis. The threshold value Nref3 is the value for estimating that the rut level Lr is 2, and is predetermined by experiment or analysis. For example, as the threshold value Nref3, the value range of about 3 to 7 is used. When the number of condition satisfying values N3 is equal to or larger than the threshold value Nref3 in step S310, it is estimated that the rut level Lr is 2 (step S320). When the number of condition satisfying values N3 is smaller than the threshold value Nref3 in step S310, it is estimated that the rut level Lr is 1 (step S330).

As described above, the inventors have found that the larger the third processed value γp[k] of each section vehicle k, the larger the rut concavity level. Therefore, the rut level Lr can be estimated for the target section by using the third processed value γp[k] of each section vehicle k. Moreover, for each management vehicle i, the second processed value Δβp[i, t] is calculated by performing high-pass filtering processing for the second slip variation quantity Δβ[i, t] and, after that, the absolute difference between the current value and the previous value of the second processed value Δβp[i, t] is calculated as the third processed value γp[i, t] (the third processed value γp[k] of each section vehicle k). This removes the low-frequency components included in the second slip variation quantity Δβ[i, t] to obtain the second processed value Δβp[i, t] and thus the third processed value γp[i, t] (the third processed value γp[k] of each section vehicle k), making it possible to estimate the rut level Lr more appropriately for the target section.

After the rut level estimation processing in steps S220 to S330 is performed to estimate the rut level Lr of the target section, it is determined whether all the road sections in the management range have been set to a target section (step S340). When it is determined that some road sections in the management range are not set to a target section, the processing returns to step S200. In this way, the processing in steps S200 to S340 is repeatedly performed while changing the target section. When it is determined in step S340 that all road sections in the management range have been set to a target section, this routine is terminated. This routine, when performed in this way, makes it possible to determine the presence or absence of a rut, and estimate the rut level Lr, for each road section in the management range. After this routine is terminated as described above, each road section in the management range is associated with the rut level Lr and the association between each road section and the rut level Lr is stored in the storage device 28.

Next, the operation of the information providing unit 24 will be described. FIG. 6 is a flowchart showing an example of the image processing routine executed by the information providing unit 24. This routine is executed when a display map, which is a map of a display range, is displayed on the display 43 in response to a user's operation on the input device 42 (for example, a person in a government office). The display range is defined by a user desired range (for example, the entire management range or a part thereof), a user desired scale, etc.

When the image processing routine shown in FIG. 6 is executed, the information providing unit 24 first selects one road section from a plurality of road sections that are included in the display map and that are not set to a target section in this routine and, then, sets the selected road section to a target section (step S400). Next, the information providing unit 24 receives the rut level Lr of the target section (step S410) and checks the received rut level Lr of the target section (step S420). When the rut level Lr of the target section is 0, it is determined not to give a rut level image, which indicates the rut level Lr, to the target section on the display map (step S430). When the rut level Lr of the target section is 1, it is determined to give the rut level image Im1 (for example, colored in green) to the target section on the display map (step S440). When the rut level Lr of the target section is 2, it is determined to give the rut level image Im2 (for example, colored in yellow), different from the rut level image Im1, to the target section on the display map (step S450). When the rut level Lr of the target section is 3, it is determined to give the rut level image Im3 (for example, colored in red), different from the rut level images Im1 and Im2, to the target section on the display map (step S460).

After that, it is determined whether all the road sections in the management range have been set to a target section (step S470). When it is determined that some road sections in the management range have not been set to a target section, the processing return to step S400. In this way, the processing in steps S400 to S470 is repeatedly performed while changing the target section. When it is determined in step S470 that all road sections in the management range have been set to a target section, this routine is terminated.

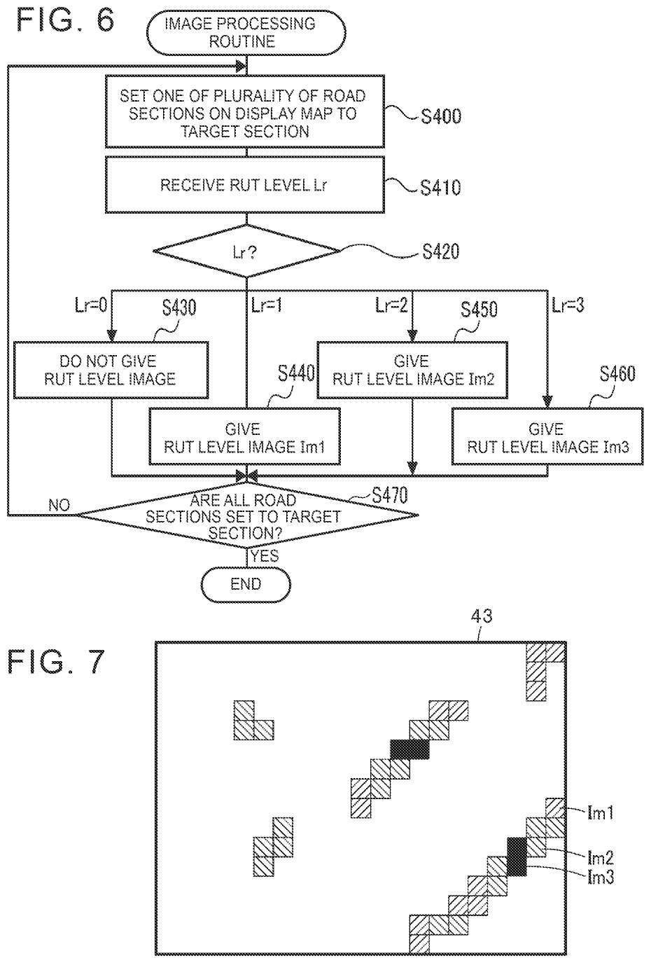

In this way, the information providing unit 24 sends the display map and the rut level images Im1 to Im3 to the terminal device 40 while executing the image processing routine in FIG. 6. The computer 41 of the terminal device 40 receives the display map and rut level images Im1 to Im3 from the server 20 and causes the display 43 to display the road sections of the display map by giving rut level images as follows: no rut level image is given to a road section when the rut level Lr is 0, the rut level image Im1 is given to a road section when the rut level Lr is 1, the rut level image Im2 is given to a road section when the rut level Lr is 2, and the rut level image Im3 is given to a road section when the rut level Lr is 3. FIG. 7 is a diagram showing an example of rut level images Im1 to Im3 included in the images displayed on the display 43. In FIG. 7, the display map is not shown for easy recognition of rut level images. Displaying the rut level images in this way allows the user to watch the display 43 for recognizing the rut level Lr of each road section on the display map.

In the server 20 provided in the road management system 10 in the embodiment described above, the presence or absence of a rut is determined for each road section in the management range based on the first processed value Δαp[i, t] (first processed value Δαp[k] of each section vehicle k). As described above, the first processed value Δαp[i, t] is calculated based on the first slip variation quantity Δα[i, t] that is calculated based on the vehicle-body slip angular velocity α[i, t] of each management vehicle i. Using the method described above makes it possible to determine the presence or absence of a rut for each road section in the management range. Moreover, the high-pass filtering processing is performed for the first slip variation quantity Δα[i, t] for each management vehicle i and, for the resulting value, the absolute value acquisition processing is further performed to calculate the first processed value Δαp[i, t]. Therefore, the first processed value Δαp[i, t] of each management vehicle i has the low-frequency components removed therefrom. This means that the method described above determines the presence or absence of a rut using the first processed value Δαp[k] of each section vehicle k in this way, making it possible to determine the presence or absence of a rut more appropriately for each road section.

In the server 20 in the embodiment, the presence or absence of a rut is determined for each road section based on the first processed value Δαp[k] of each section vehicle k. More specifically, with the first processed values Δαp[k] of each section vehicle k as a plurality of first determination values, the presence or absence of a rut is determined for each road section by comparing the number of condition satisfying values N1, which is the number of first processed values Δαp[k] included in the first processed values Δαp[k] of each section vehicle k and satisfying “Δαp[k] Δαpref”, with the threshold value Nref1 (see steps S220, S230, S240, and S260 of the rut determination processing routine in FIG. 3). However, instead of this, the presence or absence of a rut may also be determined for each road section based on any one of the first slip variation quantity Δα[k], second slip variation quantity Δβ[k], second processed value Δβp[k], and third processed value γp[k] of each section vehicle k. In this case, with any one of the first slip variation quantities Δα[k], second slip variation quantities Δβ[k], second processed values Δβp[k], and third processed values γp[k] of each section vehicle k as a plurality of first determination values, the processing similar to that in steps S220, S230, S240, and S260 of the rut determination processing routine in FIG. 3 may be performed using the absolute values of the plurality of the first determination values to determine the presence or absence of a rut for each road section. As described above, the processing such as the high-pass filtering processing is performed for the second slip variation quantity Δβ[i, t] for each management vehicle i to calculate the second processed value Δβp[i, t] and the third processed value γp[i, t]. Therefore, the second processed value Δβp[i, t] and the third processed value γp[i, t] of each management vehicle i have the low-frequency components removed therefrom in the same manner as the first processed value Δαp[i, t]. Therefore, by determining the presence or absence of a rut for each road section based on any one of the second processed value Δβp[k] and the third processed value γp[k] of each section vehicle k, the presence or absence of a rut can be determined more appropriately in the same manner as in the embodiment. This means that, when the presence or absence of a rut is determined for each road section based on any one of the first slip variation quantity Δα[k] and the second slip variation quantity Δβ[k] of each section vehicle k, the presence or absence of a rut can also be determined somewhat accurately.

In the server 20 in the embodiment, the presence or absence of a rut is determined for each road section by comparing the number of condition satisfying values N1, which is the number of first processed values Δαp[k] included in the first processed values Δαp[k] of each section vehicle k and satisfying “Δαp[k] Δαpref”, with the threshold value Nref1. However, the presence or absence of a rut may also be determined for each road section by comparing the ratio R1 of the number of condition satisfying values N1 to the number of section vehicles Nv with the threshold value Rref1. This comparison may also be used for each road section when any one of the first slip variation quantity Δα[k], second slip variation quantity Δβ[k], second processed value Δβp[k], and third processed value γp[k] of each section vehicle k is used instead of the first processed value Δαp[k] of each section vehicle k.

In the server 20 in the embodiment, the rut level Lr is estimated for each road section based on the third processed value γp[k] of each section vehicle k when it is determined that there is a rut. More specifically, with the third processed values γp[k] of each section vehicle k as a plurality of second determination values, the rut level Lr is estimated for each road section by comparing the number of condition satisfying values N2, which is the number of third processed values γp[k] included in the third processed values γp[k] of each section vehicle k and satisfying “γp[k]≥γpref1”, with the threshold value Nref2 and by comparing the number of condition satisfying values N3, which is the number of the third processed values γp[k] included in the third processed values γp[k] of each section vehicle k and satisfying “γref2≤γp[k]≤γpref1”, with the threshold value Nref3 (see steps S270 to S330 of the rut determination processing routine in FIG. 3). However, instead of this, the rut level Lr may also be estimated for each road section based on any one of the first slip variation quantity Δα[k], first processed value Δαp[k], second slip variation quantity Δβ[k], and second processed value Δβp[k] of each section vehicle k. In this case, with any one of the first slip variation quantities Δα[k], first processed values Δαp[k], second slip variation quantities Δβ[k], and second processed values Δβp[k] of each section vehicle k as a plurality of second determination values, the rut level Lr may also be estimated for each road section by performing the processing similar to that in steps S270 to S330 of the rut determination processing routine in FIG. 3 using the absolute values of the plurality of the second determination values. As described above, the first processed value Δαp[i, t] and the second processed value Δβp[i, t] of each management vehicle i have the low-frequency components removed therefrom. Therefore, by estimating the rut level Lr for each road section based on any one of the first processed value Δαp[i, t] and the second processed value Δβp[i, t] of each section vehicle k, the rut level Lr can be estimated more appropriately in the same manner as in the embodiment. This means that, when the rut level Lr is estimated for each road section based on any one of the first slip variation quantity Δα[k] and the second slip variation quantity Δβ[k] of each section vehicle k, the rut level Lr can also be estimated somewhat accurately.

In the server 20 in the embodiment, when it is determined that there is a rut, the rut level Lr is estimated for each road section by comparing the number of condition satisfying values N2, which is the number of third processed values γp[k] included in the third processed values γp[k] of each section vehicle k and satisfying “γp[k]≥γpref1”, with the threshold value Nref2 and by comparing the number of condition satisfying values N3, which is the number of third processed values γp[k] included in the third processed values γp[k] of each section vehicle k and satisfying “γref2≤γp[k]<γpref1”, with the threshold value Nref3. However, when it is determined that there is a rut, the rut level Lr may also be estimated for each road section by comparing the ratio R2 of the number of condition satisfying values N2 to the number of section vehicles Nv with the threshold value Rref2 and by comparing the ratio R3 of the number of condition satisfying values N3 to the number of section vehicles Nv with the threshold value Rref3. This comparison may also be used for each road section when any one of the first slip variation quantity Δα[k], first processed value Δαp[k], second slip variation quantity Δβ[k], and second processed value Δβp[k] of each section vehicle k is used instead of the third processed value γp[k] of each section vehicle k.

In the server 20 in the embodiment, the third processed value γp[i, t] at time t is calculated for each management vehicle i by subtracting the second processed value Δβp[i, t−1] at time (t−1) from the second processed value Δβp[i, t] at time t and, for the resulting value, by further performing the absolute value acquisition processing. However, the third processed value γp[i, t] at the time t may also be calculated for each management vehicle i by subtracting the first slip variation quantity Δα[i, t−1] at time (t−1) from the first slip variation quantity Δα[i, t] at time t and, for the resulting value, by further performing the absolute value acquisition processing. Furthermore, the third processed value γp[i, t] at time t may also be calculated for each management vehicle i by performing high-pass filtering processing for the first slip variation quantity Δα[i, t] at each time t to calculate the fourth processed value Δα[i, t] at each time t, by subtracting the fourth processed value Δα[i, t−1] at time (t−1) from the fourth processed value Δα[i, t] at time t and, for the resulting value, by further performing the absolute value acquisition processing. In addition, the third processed value γp[i, t] at time t may also be calculated for each management vehicle i by subtracting the second slip variation quantity Δβ[i, t−1] at time (t−1) from the second slip variation quantity Δβ[i, t] at time t and, for the resulting value, by further performing the absolute value acquisition processing. In these cases, the presence or absence of a rut may be determined, and the rut level Lr thereof may be estimated, for each road section, using the third processed value γp[k] of each section vehicle [k] that is based on the third processed value γp[i, t] at each time t.

In the server 20 in the embodiment, the rut level Lr is divided into three levels, 1 to 3, when there is a rut. However, the division of the rut level in the present disclosure is not limited to three levels. When there is a rut, the rut level Lr may be divided into two levels, four levels, five levels, six levels, etc.

In the server 20 in the embodiment, the presence or absence of a rut is determined, and the rut level Lr is estimated, for each road section. However, only the presence or absence of a rut may be determined for each road section without estimating the rut level Lr.

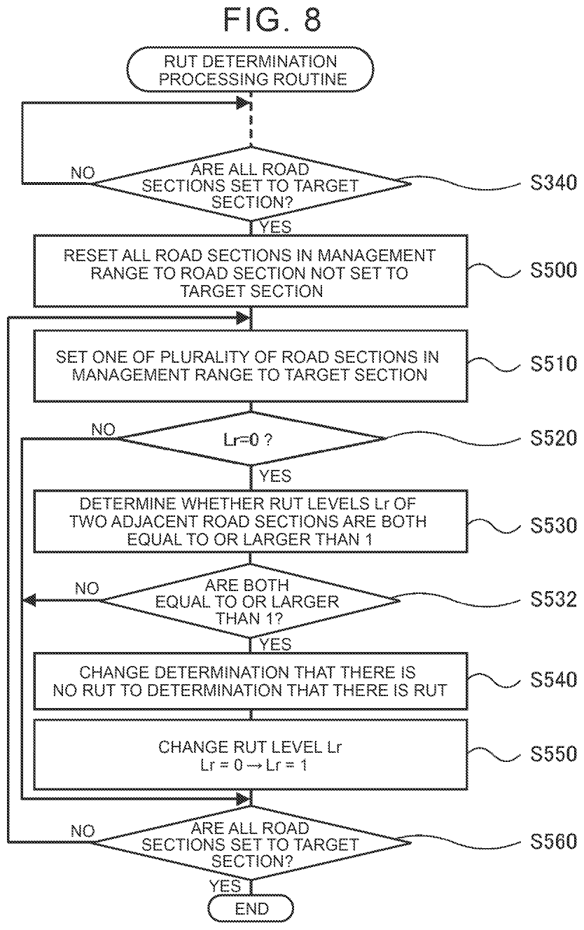

In the server 20 in the embodiment, the rut determination unit 23 executes the preparatory processing routine in FIG. 2 and the rut determination processing routine in FIG. 3. However, the rut determination unit 23 may execute the rut determination processing routine in FIG. 8 instead of the rut determination processing routine in FIG. 3. The rut determination processing routine in FIG. 8 is the same as the rut determination processing routine in FIG. 3 except that the processing in steps S500 to S560 is added after the processing in step S340. Therefore, in the rut determination processing routine in FIG. 8, the processing in steps S200 to S330 is not shown.

In the rut determination processing routine in FIG. 8, when it is determined in step S340 that all road sections in the management range are set to a target section, the rut determination unit 23 resets all road sections in the management range to a road section that is not set to a target section (step S500). After that, from the plurality of road sections that are included in the plurality of the road sections in the management range and are not set to a target section, the rut determination unit 23 selects one road section and sets the selected road section to a target section in the same manner as in the processing in step S200 (step S510).

Next, the rut determination unit 23 checks the rut level Lr of the target section (step S520). When the rut level Lr of the target section is not 0 (any of 1 to 3), that is, when there is a rut in the target section, it is determined whether all road sections in the management range have been set to a target section (step S560). When it is determined that some road sections in the management range are not set to a target section, the processing returns to step S510.

When the rut level Lr of the target section is 0 in step S520, that is, when there is no rut in the target section, it is determined whether the rut levels Lr of both of the two road sections that are adjacent to the target section in the road extending direction are equal to or larger than 1 (steps S530 and S532). When it is determined that at least one of the rut levels Lr of the two road sections adjacent to the target section is 0, that is, when it is determined that there is no rut in at least one of the two road sections adjacent to the target section, the processing proceeds to S560.

When it is determined in steps S530 and S532 that the rut levels Lr of both of the two road sections that are adjacent to the target section are equal to or larger than 1, that is, when it is determined that there is a rut in both of the two road sections, the determination that there is no rut in the target section is changed to the determination that there is a rut in the target section (step S540), the rut level Lr of the target section is changed from 0 to 1 (step S550), and the processing proceeds to step S560.

When it is determined that the rut levels Lr of both of the two road sections that are adjacent to the target section in the road extending direction are equal to or larger than 1, that is, when there is a rut in both of the two road sections, there is a possibility that, despite the fact that there is a rut in the target section (the rut continues from the target section to the adjacent sections), the number of first condition satisfying values N1 becomes less than the threshold value Nref1 in step S230 and, as a result, it is incorrectly determined in step S240 that there is no rut in the target section. Reasons for such an incorrect determination includes a shape of the road (shape in which a rut is difficult to detect) and a variation in the first processed values Δαp[k] of each section vehicle k. Taking this into consideration, this modification changes the determination as follows. That is, when the rut level Lr of the target section is 0 but when the rut levels Lr of the two road sections adjacent to the target section are equal to or larger than 1, the determination that there is no rut in the target section is changed to the determination that there is a rut in the target section and, in addition, the rut level Lr of the target section is changed from 0 to 1.

The processing in steps S510 to S560 is repeatedly performed while changing the target section in this way. When it is determined in step S560 that all road sections in the management range have been set to a target section, this routine is terminated.

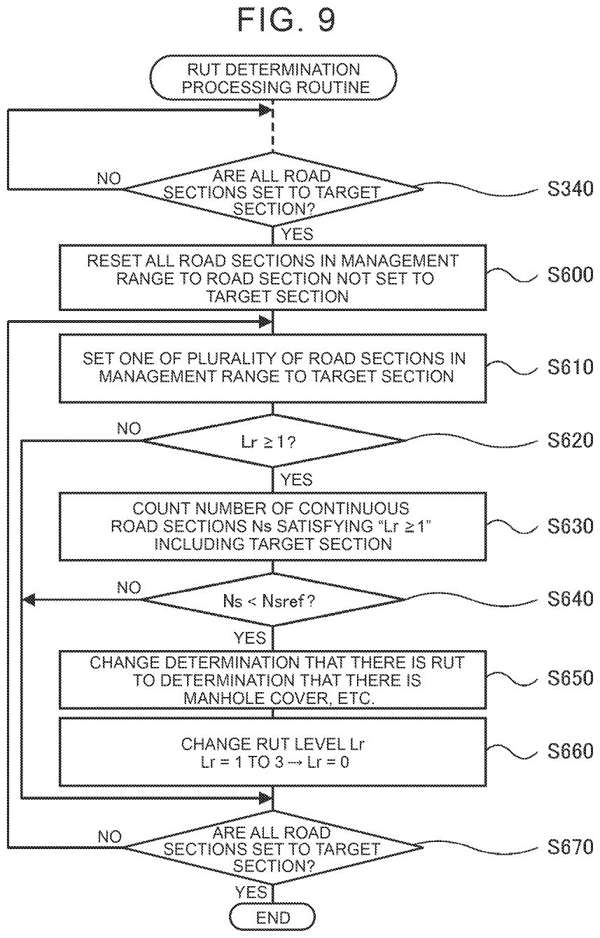

In the server 20 in the embodiment, the rut determination unit 23 executes the preparatory processing routine in FIG. 2 and the rut determination processing routine in FIG. 3. However, the rut determination unit 23 may execute the rut determination processing routine in FIG. 9 instead of the rut determination processing routine in FIG. 3. The rut determination processing routine in FIG. 9 is the same as the rut determination processing routine in FIG. 3 except that the processing in steps S600 to S670 is added after the processing in step S340. Therefore, in the rut determination processing routine in FIG. 9, the processing in steps S200 to S330 is not shown.

In the rut determination processing routine in FIG. 9, when it is determined in step S340 that all road sections in the management range are set to a target section, the rut determination unit 23 resets all road sections in the management range to a road section that is not set to a target section (step S600). After that, from a plurality of road sections that are included in the management range and are not set to a target section, the rut determination unit 23 selects one road section and sets the selected road section to a target section in the same manner as in the processing in step S200 (step S610).

Next, the rut determination unit 23 checks the rut level Lr of the target section (step S620). When the rut level Lr of the target section is 0, that is, when there is no rut in the target section, it is determined whether all road sections in the management range have been set to a target section (step S670). When it is determined that some road sections in the management range are not set to a target section, the processing returns to step S610.

When the rut level Lr of the target section is equal to or larger than 1 in step S620, that is, when there is a rut in the target section, the number of continuous road sections Ns satisfying “Lr≥1”, including the target section, is counted (step S630) and the counted number of continuous roads sections Ns is compared with the threshold value Nsref (step S640). The threshold value Nsref is a threshold value used to determine whether or not the determination that there is a rut in the target section is correct; for example, the threshold value of about 2 to 5 is used. When the number of continuous road sections Ns is equal to or larger than the threshold value Nsref, it is determined that the determination that there is a rut in the target section is correct and the processing proceeds to step S670.

When the number of continuous road sections Ns is smaller than the threshold value Nsref in step S640, it is determined that the determination that there is a rut in the target section is incorrect. In this case, the determination that there is a rut in the target section is changed to the determination that there is a manhole cover or a railroad crossing (Step S650), the rut level Lr of the target section is changed from 1-3 to 0 (step S660), and the processing proceeds to step S670.

When the number of continuous road sections Ns is small, there is a possibility that the number of first condition satisfying values N1 becomes equal to or larger than the threshold value Nref1 in step S230 because the vehicle drove over a manhole cover or passed through a railroad crossing instead of driving over a rut and, as a result, the determination in step S260, indicating that there is a rut in the target section, is incorrect. Taking this into consideration, this modification changes the determination as follows. That is, when the rut level of the target section is equal to or larger than 1 but when the number of continuous road sections Ns is smaller than the threshold value Nsref, the determination that there is a rut in the target section is changed to the determination that there is a manhole cover or a railroad crossing in the target section and, in addition, the rut level Lr of the target section is changed to 0.

The processing in steps S610 to S670 is repeatedly performed while changing the target section in this way. When it is determined in step S670 that all road sections in the management range have been set to a target section, this routine is terminated.

In this modification, the rut determination unit 23 executes the rut determination processing routine in FIG. 9 instead of the rut determination processing routine in FIG. 3. However, the rut determination unit 23 may perform the processing in steps S600 to S670 of the rut determination processing routine in FIG. 9 after performing step S560 of the rut determination processing routine in FIG. 8. Conversely, the rut determination unit 23 may perform the processing in steps S500 to S560 of the rut determination processing routine in FIG. 8 after performing the processing of step S670 of the rut determination processing routine in FIG. 9.

In the server 20 in the embodiment, the information providing unit 24 is configured to send the display map and the rut level images Im1 to Im3 to the terminal device 40 in response to a user's operation on the input device 42. However, in addition to or in place of this, the information providing unit 24 may create, for example, a list of road sections in the management range that have a rut therein and send the created list to the terminal device 40 in response to or regardless of a user's operation on the input device 42.

In the embodiment, the present disclosure is applied to the server 20 that works as the rut determination device or to the rut determination method. However, the present disclosure may be applied also to a storage medium storing a program that causes the server 20 to function as the rut determination device.

The correspondence between the main elements of the embodiment and the main elements of the disclosure described Summary will be described. In the embodiment, the rut determination unit 23 corresponds to the “processing unit.”

Since the embodiment is an example for specifically describing the mode for carrying out the disclosure described in Summary, the correspondence between the main elements of the embodiment and the main elements of the disclosure described in Summary is not intended to limit the elements of the disclosure described in Summary. That is, it should be noted that the interpretation of the disclosure described in Summary should be made based on the description in Summary and that the embodiment is simply a specific example of the disclosure described in Summary.

While the mode for carrying out the present disclosure has been described using an embodiment, it is to be understood that the present disclosure is not limited to the embodiment above. The present disclosure may be implemented in a variety of modes within the scope not departing from the spirit of the present disclosure.

The present disclosure is applicable to industries such as the manufacturing industry of a rut determination device.

What is claimed is:

1. A rut determination device configured to determine, for each road section, presence or absence of a rut based on vehicle information from each vehicle that has traveled in the each road section, the rut determination device comprising:
a processing unit configured to determine, for the each road section, the presence or absence of the rut based on any one of a plurality of first variation quantities, a plurality of first processed values, a plurality of second variation quantities, a plurality of second processed values, and a plurality of third processed values, the plurality of the first variation quantities each being a variation quantity of a vehicle-body slip angular velocity per unit time for the each vehicle, the plurality of the first processed values each being a value obtained by performing predetermined processing for each of the plurality of the first variation quantities, the predetermined processing including high-pass filtering processing, the plurality of the second variation quantities each being a variation quantity of a vehicle-body slip-related value per unit time, the vehicle-body slip-related value being a product of the vehicle-body slip angular velocity and a vehicle speed for the each vehicle, the plurality of the second processed values each being a value obtained by performing the predetermined processing for each of the plurality of the second variation quantities, the plurality of the third processed values each being a value obtained by performing arithmetic processing to obtain an absolute difference between a current value and a previous value for each of any of the plurality of the first variation quantities, the plurality of the first processed values, the plurality of the second variation quantities, and the plurality of the second processed values.

2. The rut determination device according to claim 1, wherein the processing unit is configured to determine the presence or absence of the rut by determining whether the number or ratio of first determination values is equal to or larger than a second threshold value, the number or ratio of the first determination values being the number or ratio of the first determination values that are included in a plurality of the first determination values and that each have an absolute value equal to or larger than a first threshold value, the plurality of the first determination values being any one of the plurality of the first variation quantities, the plurality of the first processed values, the plurality of the second variation quantities, the plurality of the second processed values, and the plurality of the third processed values.

3. The rut determination device according to claim 1, wherein the processing unit is configured to estimate a rut level based on any one of the plurality of the first variation quantities, the plurality of the first processed values, the plurality of the second variation quantities, the plurality of the second processed values, and the plurality of the third processed values when it is determined that there is the rut, for the each road section.

4. The rut determination device according to claim 3, wherein the processing unit is configured to estimate the rut level by determining whether the number or ratio of second determination values is equal to or larger than a fourth threshold value, the number or ratio of the second determination values being the number of the second determination values that are included in a plurality of the second determination values and that each have an absolute value equal to or larger than a third threshold value, the plurality of second determination values being any one of the plurality of the first variation quantities, the plurality of the first processed values, the plurality of the second variation quantities, the plurality of the second processed values, and the plurality of the third processed values.

5. The rut determination device according to claim 1, wherein the processing unit is configured to change a determination to a determination that there is the rut in a first target section when it is determined that there is no rut in the first target section but when it is determined that there is the rut in two road sections adjacent to the target section in a road extending direction, the target section being the road section that is a target selected from the each road sections.

6. The rut determination device according to claim 1, wherein the processing unit is configured to change a determination to a determination that there is no rut in a second target section when it is determined that there is the rut in the second target section but when it is determined that the number of continuous road sections, which include the second target section and are determined to have the rut is smaller than a fifth threshold value, the second target section being the road section that is a target selected from the each road sections.

7. A rut determination method for determining, for each road section, presence or absence of a rut based on vehicle information from each vehicle that has traveled in the each road section, the rut determination method comprising:
determining, for the each road section, the presence or absence of the rut based on any one of a plurality of first variation quantities, a plurality of first processed values, a plurality of second variation quantities, a plurality of second processed values, and a plurality of third processed values, the plurality of the first variation quantities each being a variation quantity of a vehicle-body slip angular velocity per unit time for the each vehicle, the plurality of the first processed values each being a value obtained by performing predetermined processing for each of the plurality of the first variation quantities, the predetermined processing including high-pass filtering processing, the plurality of the second variation quantities each being a variation quantity of a vehicle-body slip-related value per unit time, the vehicle-body slip-related value being a product of the vehicle-body slip angular velocity and a vehicle speed for the each vehicle, the plurality of the second processed values each being a value obtained by performing the predetermined processing for each of the plurality of the second variation quantities, the plurality of the third processed values each being a value obtained by performing arithmetic processing to obtain an absolute difference between a current value and a previous value for each of any of the plurality of the first variation quantities, the plurality of the first processed values, the plurality of the second variation quantities, and the plurality of the second processed values.

8. A non-transitory storage medium storing a program that causes a computer to function as a rut determination device configured to determine, for each road section, presence or absence of a rut based on vehicle information from each vehicle that has traveled in the each road section, the program causes the rut determination device to execute determining, for the each road section, the presence or absence of the rut based on any one of a plurality of first variation quantities, a plurality of first processed values, a plurality of second variation quantities, a plurality of second processed values, and a plurality of third processed values, the plurality of the first variation quantities each being a variation quantity of a vehicle-body slip angular velocity per unit time for the each vehicle, the plurality of the first processed values each being a value obtained by performing predetermined processing for each of the plurality of the first variation quantities, the predetermined processing including high-pass filtering processing, the plurality of the second variation quantities each being a variation quantity of a vehicle-body slip-related value per unit time, the vehicle-body slip-related value being a product of the vehicle-body slip angular velocity and a vehicle speed for the each vehicle, the plurality of the second processed values each being a value obtained by performing the predetermined processing for each of the plurality of the second variation quantities, the plurality of the third processed values each being a value obtained by performing arithmetic processing to obtain an absolute difference between a current value and a previous value for each of any of the plurality of the first variation quantities, the plurality of the first processed values, the plurality of the second variation quantities, and the plurality of the second processed values.
